(19) United States
(12) Patent Application Publication
(10) Pub. No.: US 2018/0247514 A1
(43) Pub. Date: Aug. 30, 2018

(54) Indicators

(71) Applicant: Dock Technologies Inc., Madison, WI (US)

(72) Inventor: Sarah R. Sandock, Milwaukee, WI (US)

(73) Assignee: Dock Technologies Inc., Madison, WI (US)

(21) Appl. No.: 15/832,309

(22) Filed: Dec. 5, 2017

Related U.S. Application Data
(63) Continuation of application No. 14/522,097, filed on Oct. 23, 2014, now abandoned.
(60) Provisional application No. 61/894,659, filed on Oct. 23, 2013.

(51) Int. Cl. G08B 21/18; G09G 3/04; G09G 3/16; G09G 3/34; G08B 21/02

(52) U.S. Cl. CPC G08B 21/18; G09G 3/04; G09G 3/16; G09G 2360/04; G09G 2380/04; G08B 21/02; G09G 3/344

(57) ABSTRACT

Various embodiments of indicators, their use, and their construction are described. An indicator may include a plurality of bistable display portions. The plurality of bistable display portions may be changed from a first state to a second state to indicate the passage of a predetermined time period. The plurality of bistable portions may also be changed to a third state to indicate an amount of time past the predetermined time period. An indicator may also include a plurality of event labels arranged to form an event flow path, a plurality of event inputs, and a plurality of bistable displays which may be controlled to indicate an event status.

### CROSS-REFERENCE TO RELATED APPLICATIONS

This application claims the benefit under 35 U.S.C. § 119(e) of U.S. provisional application Ser. No. 61/894,659, filed Oct. 23, 2013, the disclosure of which is incorporated by reference in its entirety.

### FIELD

Disclosed embodiments are related to indicators.

### BACKGROUND

Owing to the unique challenges in coordination and communication inherent in complex processes where time sensitive events need to occur and/or a specific event flow path needs to occur, implementation targets may not be consistent. One specific example of a challenging process is the work flow encountered by stroke care providers who may experience various challenges when trying to consistently meet treatment targets. This can be attributed to several factors. For example, emergency department stroke response is a highly dynamic process for which, on average, 10 to 15 spatially distributed team members across four departments are only assembled once a stroke code is called. Once initiated, a finely coordinated and interdependent set of tasks are performed in a transient, role-specific manner, including an array of health measurements, tests, and brain scans that must occur and be interpreted prior to treatment. Movement of the patient further complicates communication between team members making communication of even simple information an issue. Even with digital communication technologies, many emergency hospital rooms still use manual portable checklists. Further, face-to-face interactions, telephones, and pagers continue to be the primary method of communication, and up to two thirds of nurses may additionally choose to abandon electronic handoff forms in favor of older paper forms, stating they instead need information at a glance with only pertinent information using simpler tools that are known to work. Compounding this communication issue, 20% to 60% of emergency department stroke alerts are also later confirmed to be false alarms. Therefore, practitioners may feel a reduced sense of urgency in processing potential stroke victims when compared with other types of emergencies.

### SUMMARY

In one embodiment, an indicator includes one or more bistable display portions having at least a first state, a second state, and a third state. The indicator also includes a controller operatively coupled to the one or more bistable display portions. The controller changes the one or more bistable display portions from the first state to the second state to indicate the passage of a predetermined time period. The controller also changes the one or more bistable portions to the third state to indicate an amount of time past the predetermined time period.

In another embodiment, a strap includes an indicator, a first strap end operatively attached to the indicator, and a second strap end operatively attached to the indicator. Connecting the first strap end to the second strap end the indicator activates the indicator.

In yet another embodiment, an indicator includes a plurality of event labels arranged to form an event flow path and a plurality of displays associated with the plurality of event labels. An associated controller is configured to change one or more of the displays from a first state to a second state to indicate an event status.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic perspective view of an indicator;

FIG. 2 is a schematic bottom view of an indicator;

FIG. 3A is a schematic bottom view of an indicator;

FIG. 3B is a schematic cross-sectional view of the indicator of FIG. 3A;

FIGS. 4A-4C are schematic views of an indicator including bistable display portions changing between two states to indicate the passage of a predetermined amount of time;

FIGS. 5A-5D are schematic views of an indicator including bistable display portions changing between three states to indicate the passage of a predetermined amount of time;

FIGS. 6A-6D are schematic views of an indicator including bistable display portions changing between three states to indicate the passage of a predetermined amount of time and an amount of time past the predetermined amount of time;

FIGS. 7A-7J are schematic views of an indicator including bistable display portions changing between three states to indicate the passage of a predetermined amount of time and an amount of time past the predetermined amount of time;

FIGS. 8A-8C are schematic views of an indicator including bistable display portions arranged to indicate the passage of a predetermined time over multiple days;

FIGS. 9A-9C are schematic views of an indicator including bistable display portions arranged in a semi-circular pattern to indicate the passage of a predetermined amount of time;

FIG. 10 is a schematic representation of an indicator including bistable display portions arranged in two alphanumeric displays which present text in different states prior to and after the expiration of a predetermined amount of time;

FIGS. 11A-11F are schematic representations of an indicator including bistable display portions arranged in a single alphanumeric display which present text in two different states prior to and after the expiration of a predetermined amount of time;

FIGS. 12A-12B are schematic representations of an indicator including event labels, event inputs, and bistable displays to show an event flow path prior to and after inputs from a user;

FIGS. 13A-13B are schematic representations of an indicator including both decision, information, and action events of an event flow path prior to and after input from a user;

FIG. 14 is a schematic representation of an indicator incorporated in a strap;

FIG. 15 is a schematic representation of an indicator incorporated in a strap proceeding from prior to activation until after expiration of the predetermined period of time;

FIG. 16 is a schematic representation of a strap including an activation button and a timestamp indicator;

FIG. 17 is a schematic representation of a strap including separate inputs and bistable displays associated with particular events;

FIG. 18 is a schematic representation of laterally arranged electrodes to control a rectangular array of bistable displays;

FIG. 19 is a schematic representation of laterally arranged electrodes to control concentric circular bistable displays;

FIG. 20 is a schematic cross-sectional view of a device including a bistable display;

FIG. 21 is a schematic representation of an indicator including a plurality of bistable display portions arranged in an alphanumeric display; and

FIG. 22A-22C are schematic representations of the layouts of various layers in the indicator of FIG. 21.

### DETAILED DESCRIPTION

The inventors have recognized the benefits associated with communication technologies constructed to facilitate team-based communication, track the passage of time for time critical processes, and coordinating events in complex processes. In some instances, the use of indicators including simple visuals cues to provide the desired information may help facilitate the communication of information to both individuals, and/or teams of individuals, working on a time sensitive and/or complex process. Additionally, depending on the particular application, it may be desirable that the indicator not be disruptive to the workflow of individuals. For example, a simple visual reminder provided by an indicator attached to, or integrated with, a device that travels with a patient through an event, such as a stroke diagnosis and treatment process, may help keep each team member aware of relevant time points, and remind care providers of urgent time-sensitive tasks, without disrupting the normal workflow of the individuals or treatment process.

In view of the above, the inventors have recognized the benefits associated with an indicator including a plurality of bistable displays and/or bistable display portions associated with a controller in order to display relevant information related to a particular task or event. For example, the indicator may provide information regarding the passage of a predetermined time period as well as the amount of time past a predetermined time period. An indicator may also display and/or record information regarding the ordered initiation, duration, and/or conclusion of events and/or sub events within a process. Depending on the particular embodiment, an indicator may be used to present information regarding either one, some, or all of the above concepts.

With regards to the various embodiments described herein, it should be understood that any appropriate time period may be used and any appropriate time increment may be used to indicate the passage of that time period. For example, appropriate time periods may be seconds, minutes, hours, days, or any other appropriate time period. Additionally, appropriate time increments may represent seconds, minutes, hours, days, a percentage of a time period, or any other appropriate amount of time equal to, or less than, the predetermined time period.

For purposes of this application, phrases such as bistable display, bistable material, bistable pixel, bistable display portions, and other similar phrases refer to various types of display components that have two or more equilibrium states that do not require the application of an electrical potential to maintain their state. For example, an electrical potential may be applied to a bistable material to transition the bistable material between different states. Depending on the particular bistable material used in a display, these states may include a first state, a second state, a third state, or any other number of states. After changing a bistable display to a desired state, the electrical potential may be removed and the bistable display will remain in the final applied state without the need to constantly apply the potential which may help to reduce the power consumption needs of a device incorporating such a display. The bistable display may subsequently be changed to other states by applying the appropriate electrical potential. In some embodiments, the different states of a bistable display, or portion of a bistable display, may correspond to different color states. In other embodiments, the states of a bistable display, or portion of a bistable display, may be controlled to present different patterns such as circles, lines, dashed lines, crosshatching, patterns made up of other geometric shapes, or any other appropriate pattern. In yet another embodiment, one of the states of a bistable display, or portion of a bistable display, includes a burnout state. Additionally, combinations of different colors, patterns, and/or a burnout state might be used to provide a state of a bistable display, or portion of a bistable display. Appropriate materials for forming a bistable display include, but are not limited to, zenithal bistable liquid crystals, polymer stabilized cholesteric liquid crystals, electrochromic materials (which include many transition metal oxides), electrophoretic materials, easily carbonized components, and any other material appropriate to form a bistable display.

For the sake of convenience and clarity, the various displays, display portions, and display pixels described below in the various embodiments have been described relative to bistable materials. However, the various embodiments described relative to a bistable display, bistable display portion, and/or bistable display pixels may use of other types of displays as well. For example, a display might incorporate a bistable display, other types of displays, and/or a combination of a bistable display with another type of display as the disclosure is not limited to any particular display or combination of displays. Possible other types of displays include, but are not limited to, light emitting diode displays, liquid crystal displays, plasma displays, or any other appropriate display.

The various indicators described herein may be used for any number of applications. For example, the indicators may be used as visual timers and alarms. An indicator may also be used to indicate turnover, removal, and/or expiration times of a medical device, pharmaceuticals, biologics, and other disposable components and devices. In another embodiment, an indicator may be used to provide timing of time-sensitive critical care events such as the administration of medicines, treatments, and surgical procedures. Indicators may also be integrated with items such as wait tickets to indicate the amount of time a person has been waiting for a particular service including, but not limited to, hospital waiting rooms, service counters, and other appropriate locations. In some other embodiments an indicator may also be used to facilitate the communication of information between individuals across teams and task trade-offs such as might occurring during shift changes and/or transfers of work between different individuals. These types of transitions might be encountered during medical treatments, construction processes, manufacturing processes, as well as any number of other fields. Additionally, while several non-limiting applications are noted above, it should be understood that the indicators described herein should not be limited to any particular application or use.

Turning now to the figures, several non-limiting embodiments are described in further detail. While various components and features are described with regards to the different embodiments, it should be understood that the different components and features, as well as their methods of use and construction, may be used either separately or in any appropriate combination as the disclosure is not so limited.

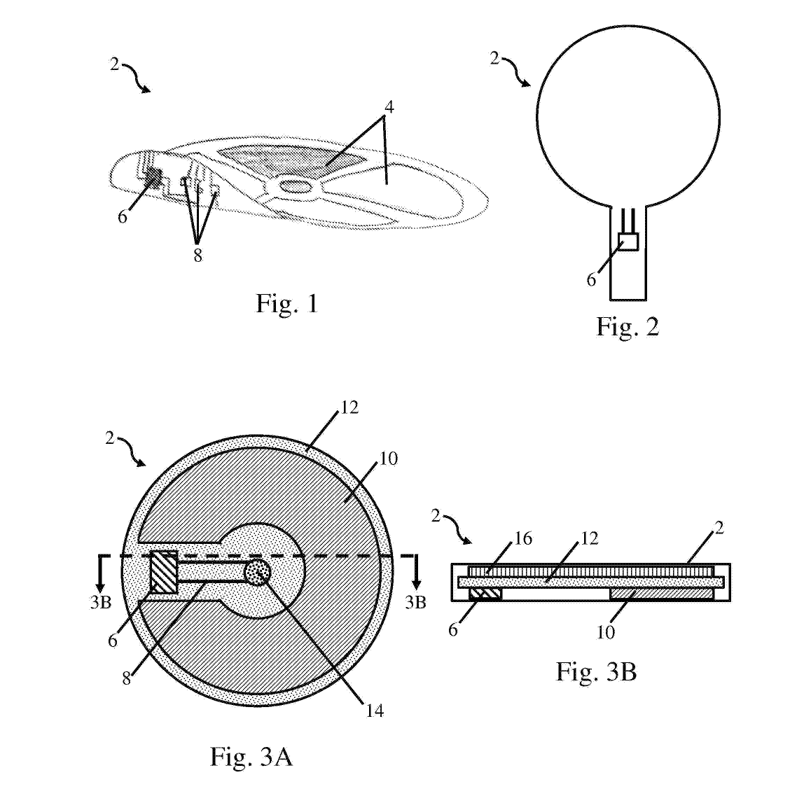

FIG. 1 depicts one embodiment of an indicator including a plurality of bistable display portions 4 having any number of different states. As noted previously, the various states may include both color states and/or pattern states of the bistable display portions. In this particular embodiment, the bistable display portions are controlled to indicate the passage of a predetermined time period. To facilitate visualization of the time, in this embodiment, the bistable display portions are sequentially arranged in a geometric pattern. For example, in the depicted embodiment, the bistable display portions 4 are shaped and arranged as four separate quadrants of a circle. Other appropriate geometric patterns include, but are not limited to, a line, a curve, a semicircle, a square, a rectangle, or any other appropriate pattern. In the depicted embodiment, each of the bistable display portions represents 25% of the predetermined time period, though other percentages might also be used. Additionally, while equally sized bistable display portions corresponding to equal amounts of time are presented, bistable display portions corresponding to different amounts of time, and/or that are sized differently from one another, are also contemplated.

In the depicted embodiment, the bistable display portions are controlled using an appropriate controller such as a microprocessor 6 as well as other electrical components 8 which may include features such as traces, vias, memory components (e.g. EEPROMs), output connections, antennas, and other appropriate devices. Depending on the embodiment, the microprocessor may include a timing circuit to measure the passage of time and/or provide an absolute time. Alternatively, a separate timing circuit, several discrete integrated circuits (ASICS), a single dedicated ASIC, or solid state logic component may be used to provide the desired timing functionality. In the depicted embodiment, the microprocessor and other electrical components are disposed on an underside of the indicator. However, it should be understood that the various electrical components and displays described herein may be arranged in any appropriate configuration as the disclosure is not so limited. For example, as illustrated in FIG. 2, the microprocessor 6, and/or any other appropriate component, may be positioned on a portion of the indicator 7 that is separate from the bistable display portions. In one such embodiment, a printed circuit board is connected to one or more separate bistable displays.

FIGS. 3A and 3B present a bottom view and a cross-sectional view of one embodiment of an indicator 2. In the depicted embodiment, the indicator includes a polymer sheet 12. The underside of the polymer sheet includes a battery 10 as well as a microprocessor 6 and other electrical components 8. The indicator also includes an activation button 14 which may correspond to any appropriate button such as a dome button, a pressure sensitive button, a capacitive sensor, an inductive sensor, or any other appropriate input device. When the activation button 14, or other appropriate activation device, is actuated, the microprocessor 6 or other controller activates the indicator. The indicator 2 also includes an electrochromic material 16, and the associated electrodes (not depicted), which form one or more bistable display portion disposed on an opposing side of the polymer sheet. In some embodiments, the various layers and components described above are enclosed within an enclosure 18. However, embodiments in which a separate enclosure is not included are also contemplated.

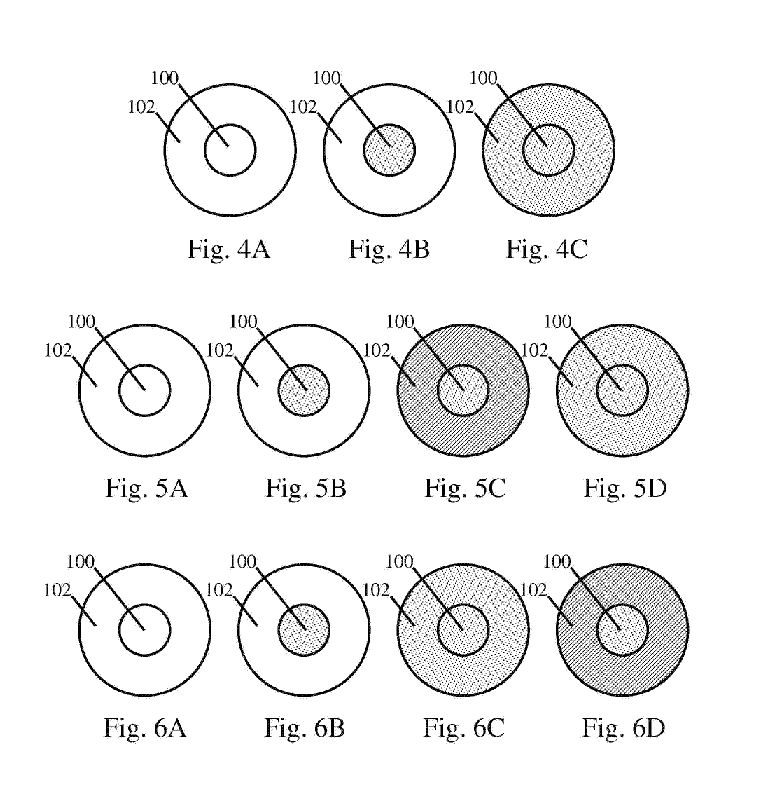

FIGS. 4A-6D depict various embodiments of indicators including a plurality of bistable display portions being sequentially changed between different states to visualize the passage of time both prior to, and after the expiration of, a predetermined time period. As illustrated in the different embodiments below, visualization of time periods may be presented using transitions between two, three, or any number of states of the bistable display portions. In the depicted embodiments, the indicators include a first bistable display portion 100 and a second bistable display portion 102.

In the embodiment depicted in FIGS. 4A-4C, the first and second bistable display portions are initially in a first state, see FIG. 4A. The first bistable display portion 100 is then changed to a second state to indicate that the indicator has been activated, see FIG. 4B. The second bistable display portion 102 is then changed to the second state as well to indicate the conclusion of the predetermined time period, see FIG. 4C. Additional intermediary states of the either of the bistable display portions may be used to indicate smaller time increments that are less than the predetermined time period. For example, as depicted in FIGS. 5A-5D, the first bistable display portion 100 changes from the first state to a final state as shown in FIG. 5B to indicate that the indicator is activated. The second bistable display portion 102 then changes from the first state to at least an intermediate second state to indicate a time increment that is less than the predetermined time, see FIG. 5C. The second bistable display portion then transitions to the final state to indicate the conclusion of the predetermined time period, see FIG. 5D.

In some embodiments, it may also be desirable to visualize time periods in excess of a predetermined time period. In one such an embodiment, a first bistable display portion 100 transitions from a first state to a second state to indicate activation of the indicator, see FIGS. 6A-6B. The second bistable display portion 102 may then transition between at least the first and second state to indicate the conclusion of the predetermined time period, see FIG. 6C. The first and/or second bistable display portions may then change to one or more additional states to indicate an amount of time that has elapsed since conclusion of the predetermined time period. For example, as shown in FIG. 6D, the second bistable display portion 102 may transition to a third state to indicate that the predetermined time period has been exceeded.

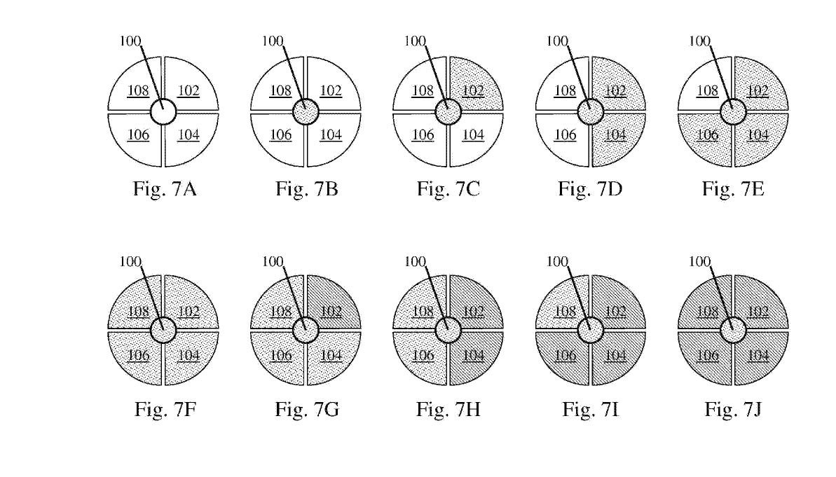

While only two bistable display portions have been depicted in FIGS. 4A-6D, it should be understood that indicators including any number of bistable display portions may be used. For example, FIGS. 7A-7J depict one embodiment of in indicator including a plurality of bistable display portions 100-108. The bistable display portion 100 corresponds to an activation display presented as a smaller circle located within the center of the other bistable display portions. The bistable display portions 102-108 are shaped and arranged as quadrants of a circle surrounding the bistable display portion 100. However, other geometric arrangements and shapes are also contemplated. In the depicted embodiment, when an associated activation device, such as an activation button, is actuated the activation indicator corresponding to bistable display portion 100 transitions from a first state to a second state to indicate that the indicator is activated, see FIGS. 7A and 7B. The bistable display portion 102 is then changed from the first stated to the second state to indicate a time between 0% and 25% of a predetermined time period, see FIG. 7C. The remaining bistable display portions 104-108 are then changed in sequence from the first state to the second state to indicate times between 25% and 50%, 50% and 75%, and 75% and 100% of the predetermined time period respectively, see FIGS. 7D-7F. The bistable display portions 102-108 are then sequentially changed to at least a third state to indicate times that are in excess of the predetermined time period by 0%-25%, 20%-50%, 50%-75%, and 75%-100%, of the predetermined time period.

While a particular number of bistable display portions corresponding to a particular range of percentages of the predetermined time period are illustrated in the figures, it should be understood that any appropriate number of bistable display portions corresponding to any appropriate percentage or duration of a predetermined time period may be used as the disclosure is not so limited. For example, the time period may be between about 0.5 hours to 1 hour, 1 hour to 3 hours, 6 hours to 12 hours, 12 hours to 1 day, 1 day to 1 week, or any other appropriate amount time. Appropriate time increments may also correspond to percentages that are between about 0.5% to 5%, 5% to 10%, 10% to 15%, 10% to 20%, 20% to 30%, 30% to 50%, 50%, to 100%, or any other appropriate time increment. The above noted time increments may also correspond to any desired amount of time including, for example, increments between about 1 min. to 10 min., 10 min. to 20 min., 20 min. to 40 min., 40 min. to 60 min., 1 hour to 6 hours, 6 hours to 12 hours, 12 hours to 1 day, 1 day to 1 week, or any other desired time increment. In addition to the above, it should be understood that while bistable display portions corresponding to equal time increments have been illustrated, bistable display portions corresponding to unequal increments using combinations of any of the above noted time increments may also be used.

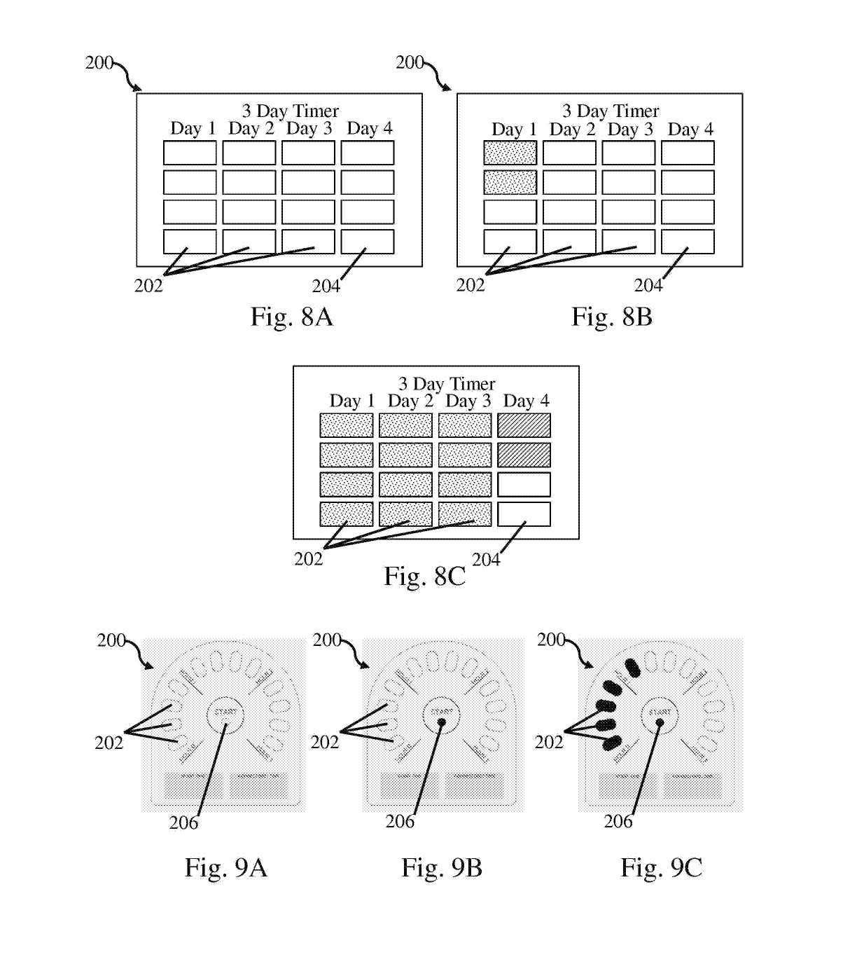

Embodiments of indicators including bistable display portions arranged to visualize different time periods and increments are depicted in FIGS. 8A-9C.

FIGS. 8A-8C depict an embodiment of an indicator 200 corresponding to a three day timer. The indicator includes multiple bistable display portions 202 and 204. The bistable display portions 202 are arranged in three columns with each column including four separate bistable display portions corresponding to 6 hour increments of days 1 through 3. The bistable display portions 204 are also arranged in a fourth column including four bistable display portions corresponding to six hour increments of day 4 which are in excess of the predetermined time period of three days. During use, the bistable display portions 202 corresponding to days one through three are sequentially changed from a first state to a second state to provide a visualization of the passage of time, see FIGS. 8A and 8B. After completion of the predetermined time period, the bistable display portions 204 are sequentially changed from the first state to a third state to indicate the amount of time in excess of the predetermined time period of three days, see FIG. 8C. For example, the bistable display portions 202 may transition from white to green and the bistable display portions 204 may transition from white to red.

FIGS. 9A-9C depict an embodiment of an indicator used to visualize a 3 hour time period. The indicator includes a plurality of bistable display portions 202 arranged in a semi-circular pattern with each bistable display portion corresponding to a 15 minute increment. The bistable display portions are arranged between text indicating the 1 hour, 2 hour, and 3 hour marks. Once activated, an activation indicator 206 transitions from a first state to a second state to indicate that the device is activated, see FIGS. 9A and 9B. The bistable display portions 202 are then changed in sequence from the first state to the second state to indicate the passage of 15 minute increments up to the final predetermined time period of 3 hours.

While the previously depicted embodiments have included graphic visualizations of a time period, in some embodiments, one or more alphanumeric displays including one or more separate bistable display portions may be used to display information. Depending on the particular embodiment, the alphanumeric display may simply present a single character such as a single number, letter, or other character. For example, the number of hours or minutes might be displayed, or a representative character such as an “X” to indicate the expiration of the time period, though other types of characters might also be used. Alternatively, in some embodiments, an alphanumeric display may display multiple characters such as, for example, multiple numbers or characters detailing a time or message. In one specific embodiment, the multiple characters may spell out a message such as T I M E I S U P, or other appropriate message. Additionally, depending on the embodiment, the alphanumeric display may only be changed once during operation of the indicator. However, in some embodiments, an alphanumeric display may be changed multiple times to display different characters during operation as might happen during a countdown or countup.

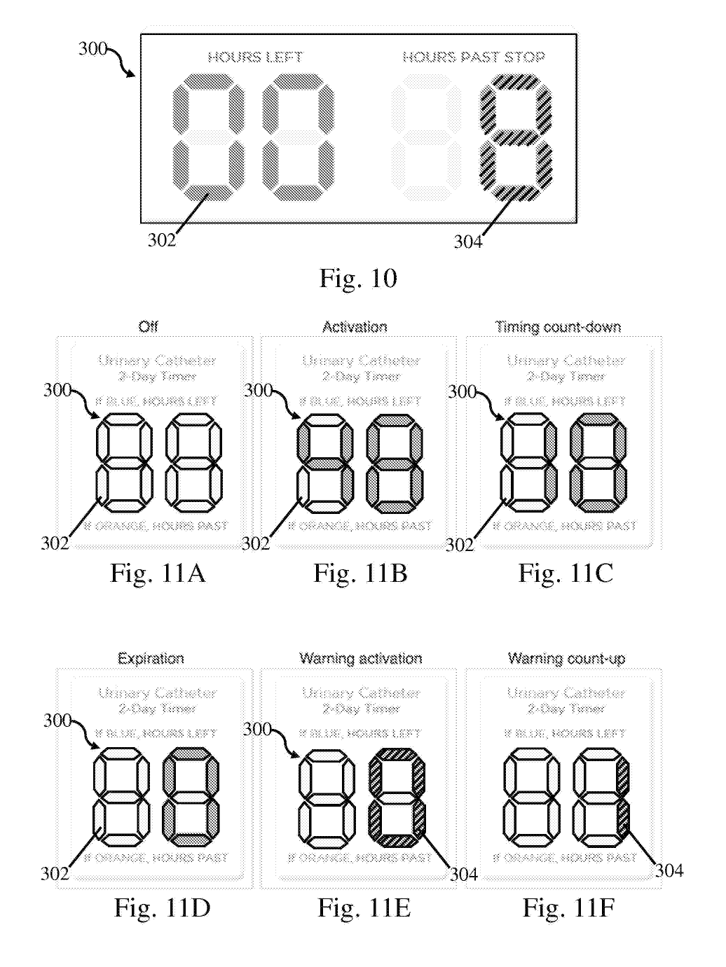

FIG. 10 presents one embodiment of an indicator 300 including a first and second set of bistable display portions 302 and 304 arranged in two separate 7-segment display arrangements to present alphanumeric characters. In the depicted embodiment, the first set of bistable display portions 302 transition between a first state and a second state to display the number of hours left in a predetermined time period. After expiration of the predetermined time period, the second set of bistable display portions 302 transition between the first state and a third state to display the number of hours that have passed in excess of the predetermined time period. The first, second, and third states may correspond to any appropriate color or pattern as noted above. However, in one embodiment, the first state is clear or white, the second state is blue, and the third state is orange.

FIGS. 11A-11F present another embodiment of an indicator 300. In the depicted embodiment, the indicator includes a first set of bistable display portions arranged in a seven-segment display arrangement to display alphanumeric characters. Once activated, the bistable display portions 302 are controlled to countdown the remaining time of a predetermined time period, FIGS. 11A-11D. However, embodiments in which the indicator counts up to the predetermined time period are also contemplated. During the predetermined time period, the bistable display portions transition between a first state and a second state to present the desired information. After the predetermined time period has expired, the bistable display portions are controlled to indicate an amount of time that has passed in excess of the predetermined period, see FIGS. 11E-11F. After the time period has expired, the bistable display portions transition between the first state and a third state to present the desired information and provide a clear visual cue that the predetermined time period has expired. For example, in one embodiment, the first state is clear or white, the second state is blue, and the third state is orange. Therefore, in this embodiment, the alphanumeric characters displayed during the predetermined time period are blue and the alphanumeric characters displayed after the predetermined time period are orange.

While alphanumeric displays including a particular arrangement of bistable display portions has been depicted in the figures noted above, it should be understood that any appropriate arrangement of bistable display portions and/or pixels might be used to present alphanumeric characters as the disclosure is not so limited. Additionally, while the bistable display portions have been described as transitioning between first, second, and third states to indicate the passage of time and the amount of time in excess of the predetermined time, transitions between additional states are also contemplated. Consequently, the current indicators should not be limited to only the specific state transitions and/or arrangements described herein.

As previously noted, in some embodiments, it may be desirable for an indicator to clearly and simply present information regarding the ordered initiation, duration, and/or conclusion of events and/or sub events during an event flow path as might happen in any number of process including, for example, clinical treatment processes. In such an embodiment, the indicator may incorporate a structured list or arrangement of events that have, or will occur. The indicator may also provide documentation of the time points at which particular actions, treatments, diagnostics, arrivals, and/or other events occur. Depending on the particular process the indicator is being used for, the arrangements of the various events along an event flow path may either be linear or nonlinear as the disclosure is not so limited. For example, a tree diagram may be appropriate for event flow paths including result, input, or context specific event paths that require different subsequent actions. Such an embodiment, might be used in applications such as patient treatment where the specific therapy to be used depends on information such as patient condition, elapsed time since certain events, location, availability of treatments, results of diagnostics, and other appropriate inputs. Additionally, in some embodiments, and as described in more detail below, the indicator may also be used to facilitate the collection, documentation, analysis, reporting, evaluation, planning, and/or implementation of the events in a particular process.

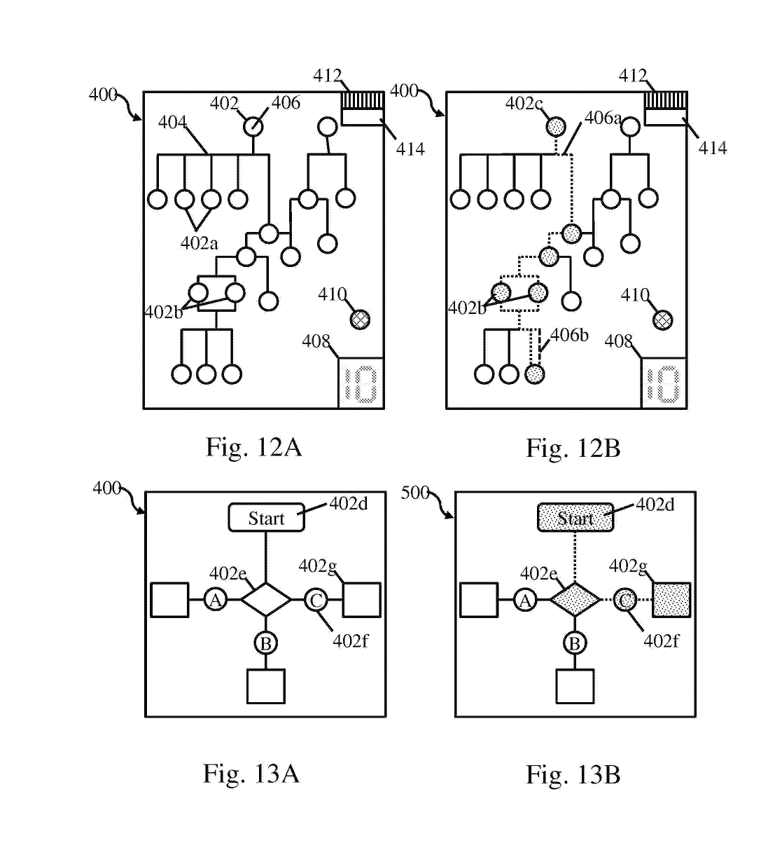

In one embodiment, the event labels and event inputs associated with particular events may be arranged in any appropriate manner to depict an event flow path. This arrangement may correspond to linear and/or nonlinear arrangements. Processes where a sequential progression of tasks are performed may be appropriate for presenting in a linear fashion. However, many processes are nonlinear in nature and include events that are performed in parallel and/or may include events that are exclusive to one another in addition to performing sequentially arranged events. Such a process may also include multiple possible starting points and/or decisions that will affect the tasks that are performed. For example, the next steps in the treatment of a patient, or maintenance of a device, may depend on the results of a particular diagnostic. There are multiple examples of exclusive events 402a present in FIGS. 12A and 12B. In some embodiments, only one of the exclusive events along a particular portion of an event flow path may be selected. In such an embodiment, events that have been excluded may be changed to a state that indicates they are no longer available (e.g. the displayed state may be red, black, a crossed out pattern, or other appropriate state). The figures also show an example of two events 402b being performed in parallel. In some embodiments, the next event in the process cannot be input into the indicator until the previous parallel events are completed, though embodiments in which the next event may be input without completing the parallel events are also contemplated. In one embodiment, events that still need to be completed may be presented using a first state such as green, events that cannot be completed yet are presented using a second state such as red, and events that have been completed may be presented using a third state such as blue.

It should be understood that an event flow path 404 may correspond to any appropriate arrangement of event labels 402 and/or event inputs 406 capable of depicting the desired sequence of events in a process. Therefore, in some embodiments, the event flow path may simply correspond to an arrangement of event labels and/or event inputs. Alternatively, and as depicted in FIGS. 12A and 12B, the event flow path 404 may also include one or more lines extending between the event labels and/or event inputs. In one embodiment, the event flow path includes individual bistable displays extending between events that are constructed to transition between at least two states to depict whether or not a particular event has occurred and/or what event should occur next in a process. The state changes may again be presented as a color change (e.g. green to blue), a pattern change (e.g. going from a solid to dashed line, forming the line with different adjacent shapes such as circles or X's), or any other appropriate state change of the bistable displays. In some embodiments, the bistable displays associated with the event flow path may be provided in addition to a permanent line used to depict the event flow path. In such an embodiment, the bistable displays may be located next to, co-located with, or distanced from the permanent line.

FIGS. 12A and 12B depict one possible embodiment of an indicator 400. In the depicted embodiment, a plurality of event labels 402 are arranged along an event flow path 404. The event labels correspond to individual events that occur along the event flow path and may be presented using either text or icons as the disclosure is not so limited. For example, an icon of a CT scanner might be used in indicate performing a CT scan of a patient. The indicator also includes a plurality of event inputs 406 operatively associated with the plurality of event labels. The event inputs may correspond to any number of different features capable of inputting information to the indicator such as any appropriate button or sensor. In the depicted embodiment, the event labels 402 and the event inputs 406 are co-located. The indicator 400 also includes a plurality of bistable displays associated with the plurality of event labels and/or the event flow path 404. In this particular embodiment, the bistable displays are co-located with the event labels and event inputs. However, embodiments in which one or more of these features are not co-located with each other are also contemplated. The indicator also includes a controller 414 that is in electrical communication with the event inputs as well as the bistable displays associated with the event labels and/or event flow path. The controller controls the state of the bistable displays in order to visualize a status of the various events and/or the next events to be performed.

In some instances, a particular process may require monitoring of multiple time periods and/or event flow paths. In such embodiments, it may be desirable to provide multiple indicators to track the multiple time periods and/or event flow paths. For example, treatment protocols requiring a series of steps to be performed at discrete times may necessitate the use of one or more indicators including one or more bistable displays to facilitate the visualization of the various steps and associated predetermined time periods of a particular process. In one such embodiment, it may be desirable for an indicator presenting an event flow path of a process to also include a timer 408 to help ensure that the process is completed in a timely fashion. Such an embodiment is shown in FIGS. 12A and 12B which depict both a timer 408 and event flow path 404 integrated into the same device. Depending on the embodiment, the multiple indicators may either be assembled in a single device such as that shown in FIGS. 12A and 12B, or they may be separately attached to a device or patient. In some embodiments, it may be desirable to activate all of the associated indicators and/or displays in order to monitor the progress of the entire process. However, embodiments in which the individual indicators and/or displays are activated separately are also contemplated.

Having described the various components of the indicator 400, its operation is described in more detail. During operation a user actuates selected event inputs 406. The selected event inputs are communicated to the controller 414. The controller then changes the bistable display associated with the particular events from a first state to a second state to indicate that a particular event has been completed. This state change of the bistable displays is shown by the selected events 402c in FIG. 12B. The controller may also change one or more bistable displays associated with the event flow path 404 from a first state to a second state to indicate a selected portion of the event flow path has been completed and/or what the next events to be performed are. These changes to the event flow path are illustrated by the dashed lines corresponding to the selected event flow path 404a in FIG. 12B.

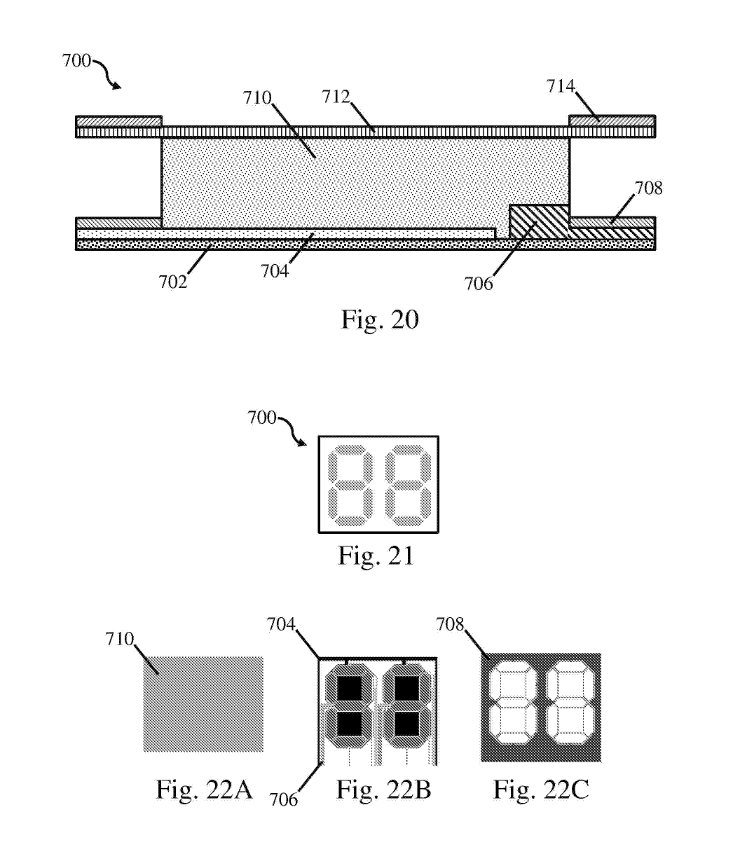

The various events located along an event flow path may correspond to any number of different events. Referring to FIGS. 13A and 13B, an event flow path may include one or more start events 402d, decision events 402e, choice and/or information events 402f, and/or action events 402g. For example, a user may actuate an input associated with the start event 402d which may simply be used to start the indicator, or may correspond to a particular starting state. In one embodiment, a particular starting state may correspond to the point of admission or condition of a patient when admitted for treatment at a hospital. The event flow path may then proceed to other events such as the decision event 402e. This might correspond to the input from a diagnostic, input of existing information, equipment availability, or may simply be a choice between different, but exclusive, actions based on user choice. In the depicted embodiment, three choices (A, B, and C) are presented which correspond to different choice and/or information events 402f. In FIG. 19B, choice C has been selected and subsequent action event 402g has been performed. These selections have resulted in the bistable displays associated with these selected events and work flow path being changed to indicate their current status as complete as also shown by the shaded events and dashed event flow path in the figure.

In some processes, it may be necessary to perform a particular event more than once. In such an embodiment, it may be desirable to configure the controller to both permit and record multiple instances of particular events. For example, an indicator 400 may include a repeat button 410 that is depressed prior to actuating a particular event input 406. The event flow path 404 may include multiple separate bistable displays extending along the event flow path in order to display repeated event. For example, and as illustrated in FIG. 12B, the primary selected event flow path 404a may be shown for a particular series of selected events and one or more repeat event occurrences 404b may be shown as one or more additional lines adjacent to the primary event flow path. These lines may be shown either with the same bistable display state as the primary event flow path, or they may be shown using another state to more clearly distinguish that a particular event has been repeated. Alternatively, a single bistable display may undergo multiple state changes to indicate how many times an event has been completed.

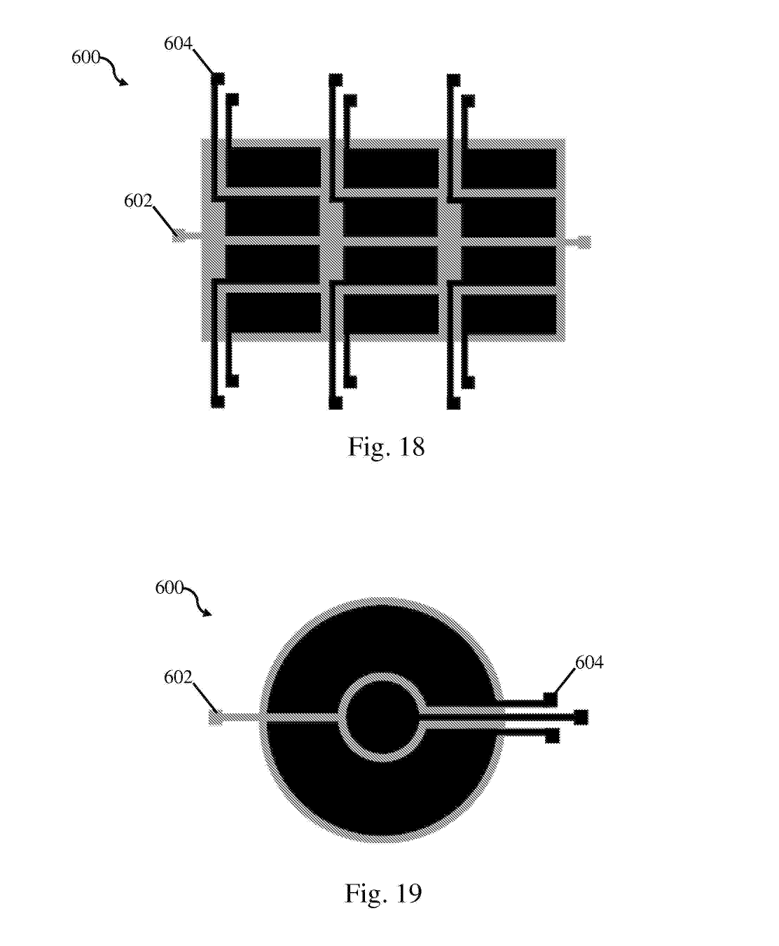

In some embodiments, a data output may be used to facilitate data transfer of information related to the use of the various indicators described above, see for example data output 412 in FIG. 18A. Depending on the embodiment, physical connectors may be used. However, in some embodiments, a wireless connection such as RFID, Bluetooth, or other appropriate device capable of communicating with another externally located computing device, network, or server, may be used. In such an embodiment, the external device may be programmed to monitor the indicator. For example, the device may be programmed to automatically alert a user that an indicator is nearing, or has reached its expiration time. Therefore, even if a user is not able to physically view the display of the indicator to determine whether or not the indicator is about to expire, the user would still have a way to monitor the status of the indicator. Additionally, the device could be programmed to monitor multiple indicators simultaneously. It should be understood that the data output may be used to output any appropriate information to another device. Appropriate information includes, but is not limited to, timestamps associated with device activation and/or particular events, event status, individuals interacting with or located within a proximity of an indicator, or any other appropriate information as the disclosure is not so limited.

In some embodiments, it may be desirable to automatically activate an indicator during usage which may help to avoid instances where an indicator is inadvertently not activated. Possible embodiments including automatic activation are described further below.

In some embodiments, an indicator is provided as an integral part of another device such that use of the device will automatically activate the indicator. For example, when the indicator is used with a medical device that is originally contained in packaging, the indicator may be integrated into the medical device in such a way that a user's opening of the medical device packaging will automatically activate the indicator. In one such embodiment, a pull tab with one end connected between the indicator battery and a circuit and another end is attached to the product packaging may be removed to activate the indicator when it is removed from the packaging. Alternatively, the automatic activation of an indicator may be achieved using a magnetic coupling between the packaging and a component such as a reed switch in the indicator. Correspondingly, a portion of the packaging may include a magnetic component which applies a magnetic field to the indicator circuitry to form a short between the battery and circuitry prior to usage. Once the packaging is removed, the switch opens, connecting the battery to the circuitry and activating the indicator. Alternatively, such an arrangement may be applied in the reverse configuration such that the device is activated when a magnetic field is applied. In another embodiment, an electrical circuit may be completed when the device is attached to a surface or when portions of the device are attached to itself.

In yet another embodiment, an indicator may be incorporated into the packaging of products covered by a film, foil, or any other type of wrapping or seal. The indicator may then be automatically activated in response to a user's peeling off the wrapping or seal of the product. As one example, the indicator could be incorporated into a wound covering having an adhesive underside. In such an embodiment, the indicator would be incorporated into the wound covering such that a user's removal of the protective film strips initially covering the adhesive underside of the wound covering would automatically activate the indicator disposed on the top side of the wound covering.

For embodiments where a product including an indicator has a cap or lid, the indicator may be automatically activated in response to a user's twisting off the cap or otherwise opening of the container lid. For example, when the indicator is used with catheters, catheters extension tubing, or other tubing having a cap that initially protects the tubing prior to use, the indicator may be integrated into the tubing such that removal of the cap prior to use of the tubing will automatically activate the indicator.

In another embodiment for products including a container closed by a septum or other pierceable sealing mechanism, an indicator may automatically activate in response to the septum or sealing mechanism being pierced. As an example, when the indicator is incorporated into an IV or blood bag, the indicator may be incorporated into the device such that attachment of an adapter or syringe to the IV or blood bag port will automatically activate the indicator by depressing a sensor or button during activation or completing an electrical circuit integrated into the connection or septum. Other types of activation methods are also possible. For bags having more than one port, e.g. bags having one or more inlet ports and one or more separate outlet ports, the bag may be provided with multiple indicators. In such an embodiment, each of the separate, discrete ports may be provided with its own individual automatically activated timing system, allowing a user to monitor the individual time information relevant to the use of each of the ports.

While automatic activation methods are described above, embodiments in which the indicators not activated automatically are also contemplated. In one such embodiment, the indicator includes a pressure sensitive, capacitance sensitive, light-sensitive, and/or inductive sensitive button or sensor configured to activate operation of the device. In another embodiment, the indicator may be wirelessly initiated using a combination of passive and active wireless components. For example, complementary portions of a passive and/or active radiofrequency communication system may be used to activate the indicator. In view of the above, it should be understood that the indicators described herein may be activated in any appropriate fashion as the disclosure is not so limited.

In some embodiments, it may be desirable to incorporate one or more of the indicators as described herein in various devices in order to provide enhanced functionalities and/or time monitoring of the expiration and/or usage of a device or the materials contained therein. Depending on the embodiment, the indicator may be provided as an integral part of products such catheters and other medical tubing, IVs, IV bags, surgical drains, bandages or other wound coverings, feeding tubes, pharmaceutical containers, biologics containers, medicine containers, blood bags, organ transplant containers, patient identification tags, other disposable and/or reusable medical devices, or any other appropriate device. While medical devices and applications are noted above, the indicators described herein may be used with non-medical devices and processes as well including, for example, products requiring assembly might include an indicator with infants flow path indicating how to assemble products, products with limited lifetimes may include an indicator that functions as a timer, products with a limited lifetime such as time sensitive adhesives may also include an indicator functions as a timer, as well as other possible devices and applications. An indicator may also be incorporated into a device in any number of ways. For example, in one embodiment, the device and the indicator are manufactured as a single monolithic unit. In another embodiment, the product and the indicator are manufactured as separate components that are subsequently joined together using any appropriate method including, but not limited to, ultrasonic welding, molding, encapsulation, and adhesives.

In one specific embodiment, an indicator may be incorporated into a strap such as a wristband. Additionally, in some embodiments, the indicator may be automatically activated once the strap has been attached to a user or intended object. For straps having an adhesive closure, the indicator may be incorporated into the device such that the removal of the protective film covering the adhesive automatically activates the device. For straps having a snap closure, the timing device may be incorporated into the device such that the closure on the snap fastener of the wristband automatically activates the indicator. Alternatively, other arrangements may be used such that when the first and second ends of the strap are brought together they activate the device. For example, electrical contacts, or connections might be located on the ends or surfaces of the strap. Therefore, when the strap ends are connected to one another they complete an electrical circuit activating the device.

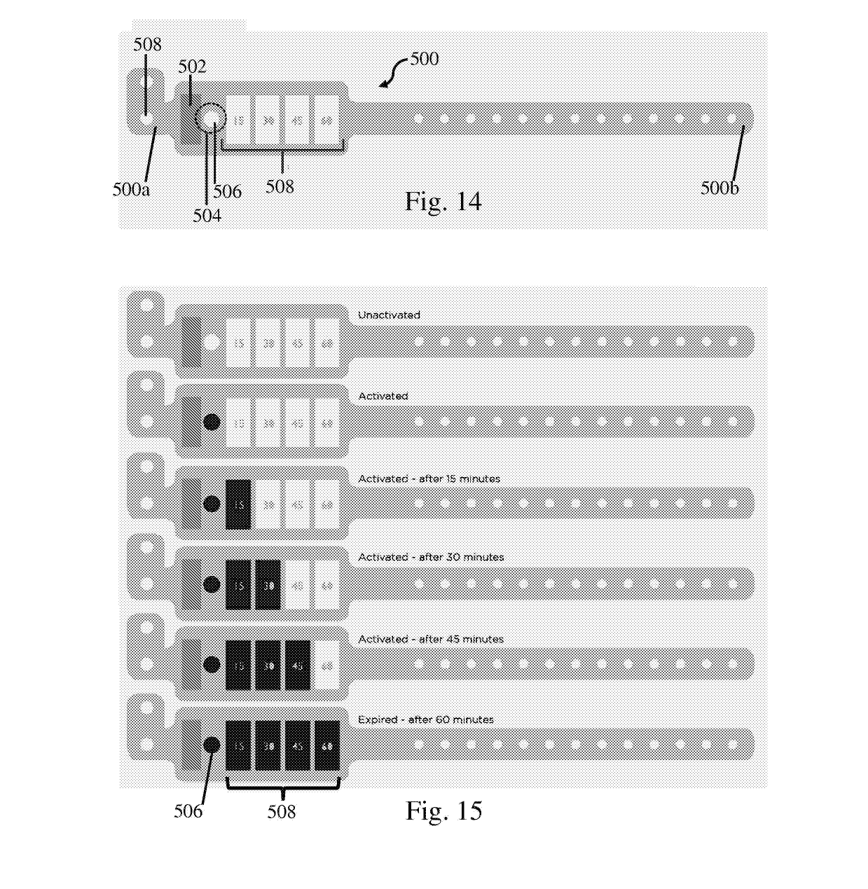

One particular embodiment of an indicator incorporated into a strap 500 is shown in FIG. 14. In some embodiments, the strap is a wristband for attaching to a person. In the depicted embodiment, the strap includes an input 502. The input may simply correspond to a field where a user may write desired information. Alternatively, the input may correspond to one or more bistable displays used to display information regarding desired information such as the time of activation, patient information, usage information, the nature of the process or emergency, or any other appropriate information. In such an embodiment, the information being displayed may be input using an appropriate physical connection and/or wireless connection as described above. The strap also includes an activation button 504 co-located with a first bistable display portion 506 that changes from a first state to a second state to indicate the activation of the indicator incorporated in the strap. The strap also includes a second set of bistable display portions 508 shaped and arranged to indicate the passage of time and/or a flow path of events as described above. The strap also includes first and second ends 500a and 500b. The first end 500a includes a connector 510 which interacts with one or more holes on the second end 500b. However, embodiments in which other connection arrangements such as adhesives, clasps, and other appropriate arrangements are used are also contemplated. Additionally, it should be understood that while the depicted strap includes an activation button, embodiments in which the incorporated indicator is activated automatically when the first and second ends are connected to one another are also contemplated as described above.

The operation of the strap 500 depicted in FIG. 14 is presented in FIG. 15. As shown in the figure, when activated the first bistable display portion 506 changes from a first state to a second state to indicate that the indicator is activated. The various portions of the second set of bistable display portions 508 are then sequentially changed from the first state to the second state to indicate the passage of time. In this particular embodiment, the second set of bistable display portions are shaped and arranged to indicate 15 minute increments over a 60 minute time period. However, other appropriate time periods and time increments may be used as the disclosure is not so limited.

For certain applications, it may be desirable to record the time associated with various events visualized and/or recorded by an indicator. For example, the start time of an indicator may be recorded. Additionally, the times associated with the various events recorded by an indicator may also be stored. The recorded times may either be measured relative to the activation time of an indicator, or they may correspond to absolute times provided by a clock, an internal timing circuit, an externally located computing device, or other appropriate source. The recorded times associated with the various events may be stored on any appropriate memory device including, but not limited to, RAM, flash memory devices such as EEPROM's, or any other appropriate component. Additionally, depending on the particular embodiment, the recorded times may either simply be stored in the memory for subsequent download, and/or the recorded times may be displayed using one or more bistable displays on the indicator.

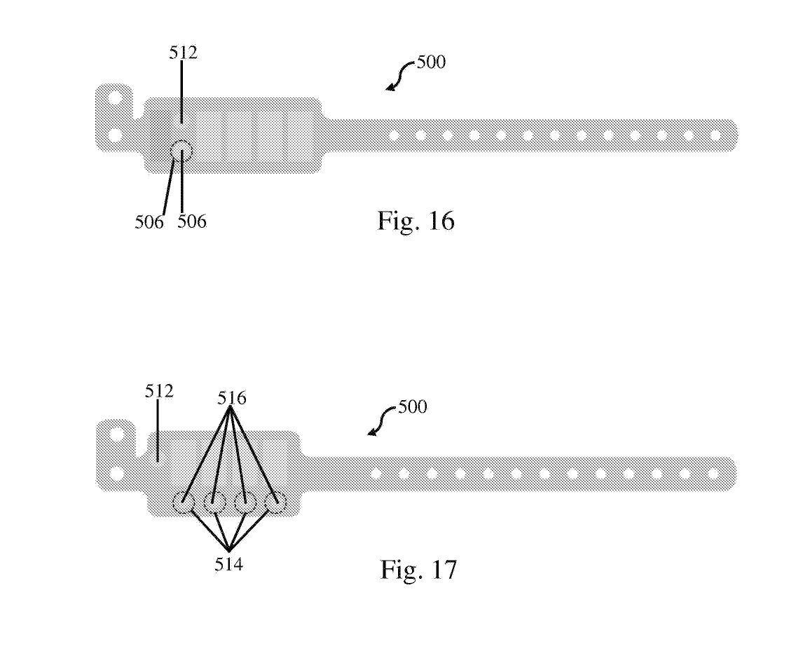

In some embodiments, it may be desirable to provide a visual indication to a user when the time associated with a particular user input or event has been recorded by an indicator. For example, as depicted in FIG. 16, a strap 500, or other appropriate device, including an indicator may include an activation button 504 and a bistable display portion 512 that is configured to indicate when a time has been recorded by the device. For example, in one embodiment, the bistable display portion 512 pulses between a first state and a second state each time the activation button is actuated indicating that the times have been recorded by the indicator.

In other embodiments, times may be recorded for discrete separate events. For example, as depicted in FIG. 17, a strap 500, or other appropriate device including an indicator, has a plurality of event inputs 514 and corresponding bistable display portions 516. The event inputs and corresponding bistable display portions are arranged in a linear configuration and may correspond to various immediate events to be completed. However, as described above, other arrangements of an event flow path, including nonlinear arrangements, are also contemplated. In this embodiment, when the inputs 514 are actuated, the bistable display portion 512 undergoes an appropriate state change, such as pulsing between two or more states, to indicate that a time for a particular event has been recorded. Additionally, as previously noted, in some instances it may be desirable to record multiple times associated with multiple occurrences of an event. Therefore, in some embodiments, one or more of the inputs 514 may be actuated multiple times and the actuation time for each event may be recorded and confirmed by activation of the bistable display portion 512.

While the above embodiments regarding recording times associated with various events have been described relative to an indicator incorporated in a strap, it should be understood that these concepts may be applied to any appropriate indicator which may be used either separately or in combination with another device as the disclosure is not so limited.

The indicators described herein may be provided using any appropriate construction. However, in some embodiments, the indicators are constructed using bistable display portions having laterally arranged electrodes. Such an arrangement may help to avoid the use of typical vertical electrode stacks which include optically transparent electrodes such as indium tin oxide (ITO). Such an arrangement may also help to simplify manufacturing processes by permitting the use of manufacturing methods like printing and screen printing. This may help to reduce materials costs, facilitate scalability, and minimize manufacturing costs. FIGS. 18 and 19 present several nonlimiting embodiments of lateral electrode layouts 600 including counter electrodes 602 and working electrodes 604. The insulating material located between the electrodes is not shown in the depicted embodiment. The electrode layout shown in FIG. 18 corresponds to three columns and four rows of bistable displays laid out in a rectangular arrangement. The electrode layout shown in FIG. 19 corresponds to bistable displays arranged in concentrically arranged circular patterns. Other electrode patterns are also contemplated.

FIG. 20 depicts one embodiment of an indicator 700 including a lateral electrode arrangement. In the depicted embodiment, the indicator includes a polymer substrate 702 as well as first and second laterally arranged electrodes 704 and 706. In some embodiments, the polymer substrate is a thin flexible polymer film which may facilitate the indicator conforming to a desired shape and/or curvature as might happen when applied to the surface of an object or when incorporated in a device. The indicator also includes dielectric material 708 as well as a layer 710 including electrolyte and/or an appropriate bistable material such as an electrochromic material. The indicator also includes a transparent covering 712 such as transparent PET. The enclosure 714 may be applied to an upper surface and/or extended around the outer boundaries of an indicator as might happen when the indicator is located on an outer surface of a device. FIGS. 21-24C depict vertical views of the overall indicator 700 and individual layers of the electrolyte and/or bistable material 710, first and second electrodes 704 and 706, and the dielectric material 708.

It should be understood that while particular electrode and layer arrangements have been shown in the figures, any appropriate electrode arrangement may be used. For example, while lateral electric arrangements are described above, embodiments in which vertical electrode stacks, or any other appropriate electrodes configuration, are used are also contemplated.

Depending on the embodiment, the electrode and layer arrangements may facilitate the use of layer and printing based manufacturing techniques. Therefore, a number of different components and layers may be directly deposited or printed onto a substrate such as the polymer substrate. This may facilitate the use of thin-film or printed batteries as depicted in FIGS. 3A and 3B. Additionally, in some embodiments, a substrate on which the materials are deposited, such as the depicted polymer sheet, is a flexible thin-film which may help to facilitate the indicator conforming to a surface it is attached to, or integrated with.

In some embodiments, an indicator may include various components that are sensitive to either water and/or atmospheric gases. Therefore, it may be desirable to isolate these components from the external environment. Therefore, in one embodiment, an enclosure that at least partially surrounds the indicator, or at least encloses one or more components of the indicator, is water and/or gas impermeable to help prevent damage to the desired components. However, embodiments in which an enclosure is not used, or in which the enclosure is not water or gas impermeable, are also contemplated.

In embodiments where the enclosure covers one or more displays portions of an indicator, it may be desirable to be able to view the displays through the enclosure. Consequently, in one embodiment, the enclosure is optically transparent to facilitate view the display portions.

In the above noted embodiments, the indicator has included a battery. However, embodiments in which the indicator does not include a battery are also contemplated. For example, an indicator may include an appropriate device for the wireless transfer of power such as an induction coil. Such an arrangement may be used to enable power transfer from an external device to the indicator. In some embodiments, this may eliminate the need for a separate battery and/or timing circuit as the power and/or timing of the indicator may be controlled by a separate external power source that would control when power is provided to the indicator.

For processes including multiple team members, it may be desirable to track who has interacted with a particular indicator or been within a certain range of the indicator. This functionality may be provided in any number of ways. For example, in one embodiment, the indicator may include an active radio frequency component that can scan corresponding radiofrequency ID's brought within its sensor range. Alternatively, the indicator may include a component that is sensitive to an active signal provided by an individual's ID. In another embodiment, the indicator may include a magnetic or inductive sensor capable of accepting inputs to identify particular individuals interacting with the indicator. In view of the above, it should be understood that any appropriate method and/or component capable of sensing individuals interacting with, or located within a proximity of, an indicator may be used as the disclosure is not so limited.

In order to provide additional communication and integration across multiple team members involved in a particular process, in some embodiments, an indicator may be configured to interact with an augmented reality and/or a connected device. For example, in one embodiment, an augmented reality device, such as Google glass or a DAQRI Smart Helmet, or a connected device, such as a smart phone or connected handheld device, may be used with a particular indicator. Regardless of the particular device being used, the device is configured to recognize the presence of the indicator. After recognizing the presence of the indicator, the device identifies the indicator using imaging of an indicator ID such as a barcode, identifying a location of the indicator within a known area (e.g. cross referencing the location of the indicator with a list of various indicator locations), wireless communication of an indicator ID, or any other appropriate method capable of identifying the particular indicator. After identifying a particular indicator, a device may communicate with the indicator or a remotely located server, network, or other computing device to download information related to the indicator. For example, the device may download information such as patient history, the last person to interact with the indicator, previous events, ongoing events, diagnostic results, and/or next steps that need to be completed in a particular process. This ready availability of information related to a particular process, such as a complex medical treatment, may help to facilitate communication amongst team members and improve outcomes and efficiencies.

Depending on the particular use, in some embodiments, an indicator may be intended for a single use. In such an embodiment, it may be desirable for the indicator to be constructed without, or at least with limited amounts of hazardous materials and restricted components. This may facilitate disposal of the indicator as common waste without the need for special treatment considerations. However, embodiments in which indicators are constructed using materials and/or components requiring special disposal and/or indicators that are intended for multiple uses are also contemplated.

While the various components and features have been described above with regards to different embodiments, it should be understood that the different components, features, and devices as well as their methods of use and construction, may be used either separately or in any appropriate combination as the disclosure is not limited to any specific embodiment. Additionally, while the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1-32. (canceled)

33. An indicator comprising:
a plurality of bistable display elements, the plurality of bistable display elements being configured to be switched among at least a first state, a second state, and a third state; and
a controller operatively coupled to the plurality of bistable display elements, wherein the controller is configured to:
switch one or more of the plurality of bistable display elements from the first state to the second state upon activation of the indicator, and
switch one or more of the plurality of bistable display elements from the second state to the third state after a predetermined time period has passed from activation of the indicator.

34. The indicator of claim 33, wherein the plurality of bistable display elements are configured to be switched, from the first state to the second state, in a predefined order.

35. The indicator of claim 33, wherein the plurality of bistable display elements are configured to be switched, from the second state to the third state, in a predefined order.

36. The indicator of claim 33, wherein the plurality of bistable display elements are configured to be switched between the first state and the second state to present a numerical value corresponding to a remaining time or to an elapsed time.

37. The indicator of claim 33, wherein the plurality of bistable display elements are configured to be switched between the first state and the third state to present a numerical value corresponding to a remaining time or to an elapsed time.

38. The indicator of claim 33, further comprising a substrate on which the plurality of bistable display elements are disposed.

39. The indicator of claim 33, wherein one or more of the plurality of bistable display elements is configured to be switched between the first state and the second state responsive to a user-input configured to cause actuation of the one or more of the bistable display elements.

40. The indicator of claim 33, wherein switching between the first state and the second state comprises at least one of: (i) changing a color of one or more of the plurality of bistable display elements and (ii) changing a pattern of one or more of the plurality of bistable display elements.

41. The indicator of claim 33, wherein switching between the first state and the third state comprises at least one of: (i) changing a color of one or more of the plurality of bistable display elements and (ii) changing a pattern of one or more of the plurality of bistable display elements.

42. An indicator comprising:
a first set of bistable display elements configured to be switched between a first state and a second state;
a second set of bistable display elements configured to be switched between the first state and a third state; and
a controller operatively coupled to the first and second sets of bistable display elements, wherein the controller is configured to:
switch one or more of the bistable display elements of the first set from the first state to the second state upon activation of the indicator, and
switch one or more of the bistable display elements of the second set from the first state to the third state after a predetermined time period has passed from activation of the indicator.

43. The indicator of claim 42, wherein the bistable display elements of the first set are configured to be switched, from the first state to the second state, in a predefined order.

44. The indicator of claim 42, wherein the bistable display elements of the second set are configured to be switched, from the first state to the third state, in a predefined order.

45. The indicator of claim 42, wherein the bistable display elements of the first set are configured to be switched between the first state and the second state to present a numerical value corresponding to a remaining time or to an elapsed time.

46. The indicator of claim 42, wherein the bistable display elements of the second set are configured to be switched between the first state and the third state to present a numerical value corresponding to a remaining time or to an elapsed time.

47. The indicator of claim 42, further comprising a substrate on which the first set of bistable display elements and the second set of bistable display elements are disposed.

48. The indicator of claim 42, wherein switching between the first state and the second state comprises at least one of (i) changing a color of one or more of the bistable display elements of the first set and (ii) a changing a pattern of one or more of the bistable display elements of the first set.

49. The indicator of claim 42, wherein switching between the first state and the third state comprises at least one of (i) changing a color of one or more of the bistable display elements of the second set and (ii) a changing a pattern of one or more of the bistable display elements of the second set.

50. The indicator of claim 42, wherein one or more of the bistable display elements of the first set is configured to switch between the first state and the second state upon actuation of one or more of the bistable display elements of the first set by a user.
